(19) United States
(12) Patent Application Publication
(10) Pub. No.: US 2024/0057680 A1
(43) Pub. Date: Feb. 22, 2024

(54) AUTO-LOCK OF AN AEROSOL PROVISION DEVICE

(71) Applicant: RAI STRATEGIC HOLDINGS, INC., Winston-Salem, NC (US)

(72) Inventors: Sean Allan Daugherty, Yadkinville, NC (US); Nicole Brockmueller, Winston-Salem, NC (US)

(21) Appl. No.: 18/234,217

(22) Filed: Aug. 15, 2023

Related U.S. Application Data
(60) Provisional application No. 63/371,972, filed on Aug. 19, 2022.

(51) Int. Cl. A24F 40/53; A24F 40/42; A24F 40/65; A24F 40/465

(52) U.S. Cl. CPC A24F 40/53; A24F 40/42; A24F 40/65; A24F 40/465

(57) ABSTRACT

An aerosol provision device is provided that includes a coupler structured to engage a consumable including aerosol-generating material, the aerosol provision device or the consumable further including an aerosol generator. The device includes a communication interface configured to enable a wireless connection, and processing circuitry configured to control power provided to the aerosol generator to energize the aerosol-generating material of the consumable to generate aerosol for delivery to a user. And the processing circuitry is further configured to activate a timer to measure an elapsed time, and automatically lock the aerosol provision device, responsive to a timeout condition in which no computer on a whitelist of one or more computers is in wireless range of the communication interface when the elapsed time reaches a specified period of time.

### CROSS-REFERENCE TO RELATED APPLICATIONS

This application claims priority to U.S. Provisional Application No. 63/371,972, entitled: Auto-Lock of an Aerosol Provision Device, filed on Aug. 19, 2022, the content of which is hereby incorporated by reference in its entirety.

### TECHNOLOGICAL FIELD

The present disclosure relates to aerosol provision systems such as smoking articles designed to deliver at least one substance to a user.

### BACKGROUND

Many aerosol provision systems and in particular non-combustible aerosol provision systems have been proposed through the years as improvements upon, or alternatives to, smoking products that require combusting tobacco for use. These systems are generally designed to deliver at least one substance to a user, such as to satisfy a particular “consumer moment.” To this end, the substance may include constituents that impart a physiological effect on the user, a sensorial effect on the user, or both. The substance may be generally present in an aerosol-generating material that may contain one or more constituents of a range of constituents, such as active substances, flavors, aerosol-former materials and other functional materials like fillers.

Aerosol provision systems include, for example, vapor products commonly known as “electronic cigarettes,” “e-cigarettes” or electronic nicotine delivery systems (ENDS), as well as heat-not-burn products including tobacco heating products (THPs) and carbon-tipped tobacco heating products (CTHPs). Many of these products take the form of a system including a device and a consumable, and it is the consumable that includes the material from which the substance to be delivered originates. Typically, the device is reusable, and the consumable is single-use (although some consumables are refillable). Therefore, in many cases, the consumable is sold separately from the device, and often in a multipack. Moreover, subsystems and some individual components of devices or consumables may be sourced from specialist manufacturers.

### BRIEF SUMMARY

Example implementations of the present disclosure are directed to auto-lock of aerosol provision systems such as smoking articles designed to deliver at least one substance to a user. The present disclosure includes, without limitation, the following example implementations.

Some example implementations provide an aerosol provision device comprising: a coupler structured to engage a consumable including aerosol-generating material, the aerosol provision device or the consumable further including an aerosol generator; a communication interface configured to enable a wireless connection; and processing circuitry configured to control power provided to the aerosol generator to energize the aerosol-generating material of the consumable to generate aerosol for delivery to a user, the processing circuitry further configured to at least: activate a timer to measure an elapsed time; and automatically lock the aerosol provision device, responsive to a timeout condition in which no computer on a whitelist of one or more computers is in wireless range of the communication interface when the elapsed time reaches a specified period of time.

Some example implementations provide a method of operating an aerosol provision device that includes a coupler structured to engage a consumable including aerosol-generating material, the aerosol provision device or the consumable further including an aerosol generator configured to energize the aerosol-generating material of the consumable to generate aerosol for delivery to a user, the method comprising: activating a timer to measure an elapsed time; and automatically locking the aerosol provision device, responsive to a timeout condition in which no computer on a whitelist of one or more computers is in wireless range of the communication interface when the elapsed time reaches a specified period of time.

These and other features, aspects, and advantages of the present disclosure will be apparent from a reading of the following detailed description together with the accompanying figures, which are briefly described below. The present disclosure includes any combination of two, three, four or more features or elements set forth in this disclosure, regardless of whether such features or elements are expressly combined or otherwise recited in a specific example implementation described herein. This disclosure is intended to be read holistically such that any separable features or elements of the disclosure, in any of its aspects and example implementations, should be viewed as combinable, unless the context of the disclosure clearly dictates otherwise.

It will therefore be appreciated that this Brief Summary is provided merely for purposes of summarizing some example implementations so as to provide a basic understanding of some aspects of the disclosure. Accordingly, it will be appreciated that the above described example implementations are merely examples and should not be construed to narrow the scope or spirit of the disclosure in any way. Other example implementations, aspects and advantages will become apparent from the following detailed description taken in conjunction with the accompanying figures which illustrate, by way of example, the principles of some described example implementations.

### BRIEF DESCRIPTION OF THE FIGURES

Having thus described aspects of the disclosure in the foregoing general terms, reference will now be made to the accompanying figures, which are not necessarily drawn to scale, and wherein:

FIG. 1 is a block diagram of an aerosol provision system according to some example implementations of the present disclosure;

FIGS. 2 and 3 illustrate an aerosol provision system in the form of a vapor product, according to some example implementations;

FIG. 4 illustrates a nebulizer that may be used to implement an aerosol generator of an aerosol provision system, according to some example implementations;

FIGS. 5, 6 and 7 illustrate an aerosol provision system in the form of a heat-not-burn product, according to some example implementations;

FIG. 8 illustrates a system including an aerosol provision device in wireless communication with a computer from which a service platform is accessible, according to various example implementations;

FIG. 9 is a schematic diagram that illustrates a user account that may be provided by a service platform, according to various example implementations;

FIG. 10 is a state diagram of an aerosol provision device with an auto-lock setup for a timeout condition, and a low-voltage condition, according to various example implementations;

FIGS. 11A and 11B are customer journey maps for use of the aerosol provision device with an auto-lock setup for a timeout condition, according to various example implementations; and

FIGS. 12A, 12B, 12C, 12D, 12E, 12F, 12G and 12H are flowcharts illustrating various steps in a method of operating an aerosol provision device, according to various example implementations.

### DETAILED DESCRIPTION

Some implementations of the present disclosure will now be described more fully hereinafter with reference to the accompanying figures, in which some, but not all implementations of the disclosure are shown. Indeed, various implementations of the disclosure may be embodied in many different forms and should not be construed as limited to the implementations set forth herein; rather, these example implementations are provided so that this disclosure will be thorough and complete, and will fully convey the scope of the disclosure to those skilled in the art. Like reference numerals refer to like elements throughout.

Unless specified otherwise or clear from context, references to first, second or the like should not be construed to imply a particular order. A feature described as being above another feature (unless specified otherwise or clear from context) may instead be below, and vice versa; and similarly, features described as being to the left of another feature else may instead be to the right, and vice versa. Also, while reference may be made herein to quantitative measures, values, geometric relationships or the like, unless otherwise stated, any one or more if not all of these may be absolute or approximate to account for acceptable variations that may occur, such as those due to engineering tolerances or the like.

As used herein, unless specified otherwise or clear from context, the “or” of a set of operands is the “inclusive or” and thereby true if and only if one or more of the operands is true, as opposed to the “exclusive or” which is false when all of the operands are true. Thus, for example, “[A] or [B]” is true if [A] is true, or if [B] is true, or if both [A] and [B] are true. Further, the articles “a” and “an” mean “one or more,” unless specified otherwise or clear from context to be directed to a singular form. Furthermore, it should be understood that unless otherwise specified, the terms “data,” “content,” “digital content,” “information,” and similar terms may be at times used interchangeably.

Example implementations of the present disclosure are generally directed to delivery systems designed to deliver at least one substance to a user, such as to satisfy a particular “consumer moment.” The substance may include constituents that impart a physiological effect on the user, a sensorial effect on the user, or both.

Delivery systems may take many forms. Examples of suitable delivery systems include aerosol provision systems such as powered aerosol provision systems designed to release one or more substances or compounds from an aerosol-generating material without combusting the aerosol-generating material. These aerosol provision systems may at times be referred to as non-combustible aerosol provision systems, aerosol delivery devices or the like, and the aerosol-generating material may be, for example, in the form of a solid, semi-solid, liquid or gel and may or may not contain nicotine.

Examples of suitable aerosol provision systems include vapor products, heat-not-burn products, hybrid products and the like. Vapor products are commonly known as “electronic cigarettes,” “e-cigarettes” or electronic nicotine delivery systems (ENDS), although the aerosol-generating material need not include nicotine. Many vapor products are designed to heat a liquid material to generate an aerosol. Other vapor products are designed to break up an aerosol-generating material into an aerosol without heating, or with only secondary heating. Heat-not-burn products include tobacco heating products (THPs) and carbon-tipped tobacco heating products (CTHPs), and many are designed to heat a solid material to generate an aerosol without combusting the material.

Hybrid products use a combination of aerosol-generating materials, one or a plurality of which may be heated. Each of the aerosol-generating materials may be, for example, in the form of a solid, semi-solid, liquid, or gel. Some hybrid products are similar to vapor products except that the aerosol generated from a liquid or gel aerosol-generating material passes through a second material (such as tobacco) to pick up additional constituents before reaching the user. In some example implementations, the hybrid system includes a liquid or gel aerosol-generating material, and a solid aerosol-generating material. The solid aerosol-generating material may include, for example, tobacco or a non-tobacco product.

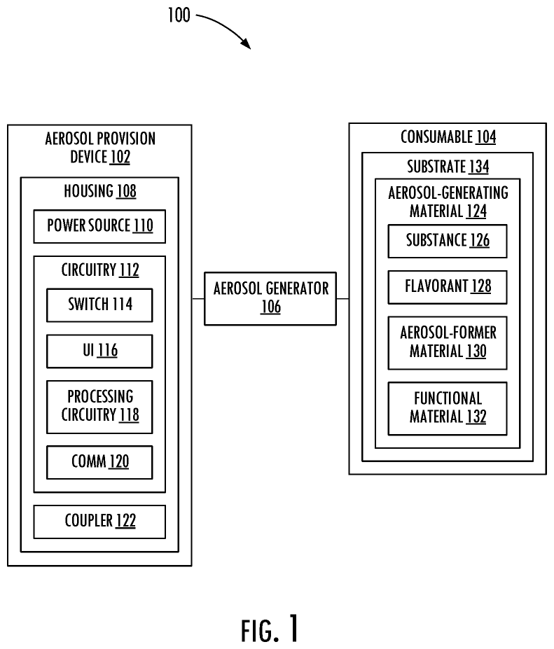

FIG. 1 is a block diagram of an aerosol provision system 100 according to some example implementations. In various examples, the aerosol provision system may be a vapor product, heat-not-burn product or hybrid product. The aerosol provision system includes one or more of each of a number of components including, for example, an aerosol provision device 102, and a consumable 104 (sometimes referred to as an article) for use with the aerosol provision device. The aerosol provision system also includes an aerosol generator 106. In various implementations, the aerosol generator may be part of the aerosol provision device or the consumable. In other implementations, the aerosol generator may be separate from the aerosol provision device and the consumable, and removably engaged with the aerosol provision device and/or the consumable.

In various examples, the aerosol provision system 100 and its components including the aerosol provision device 102 and the consumable 104 may be reusable or single-use. In some examples, the aerosol provision system including both the aerosol provision device and the consumable may be single use. In some examples, the aerosol provision device may be reusable, and the consumable may be reusable (e.g., refillable) or single use (e.g., replaceable). In yet further examples, the consumable may be both refillable and also replaceable. In examples in which the aerosol generator 106 is part of the aerosol provision device or the consumable, the aerosol generator may be reusable or single-use in the same manner as the aerosol provision device or the consumable.

In some example implementations, the aerosol provision device 102 may include a housing 108 with a power source 110 and circuitry 112. The power source is configured to provide a source of power to the aerosol provision device and thereby the aerosol provision system 100. The power source may be or include, for example, an electric power source such as a non-rechargeable battery or a rechargeable battery, solid-state battery (SSB), lithium-ion battery, supercapacitor, or the like.

The circuitry 112 may be configured to enable one or more functionalities (at times referred to as services) of the aerosol provision device 102 and thereby the aerosol provision system 100. The circuitry includes electronic components, and in some examples one or more of the electronic components may be formed as a circuit board such as a printed circuit board (PCB).

In some examples, the circuitry 112 includes at least one switch 114 that may be directly or indirectly manipulated by a user to activate the aerosol provision device 102 and thereby the aerosol provision system 100. The switch may be or include a pushbutton, touch-sensitive surface or the like that may be operated manually by a user. Additionally or alternatively, the switch may be or include a sensor configured to sense one or more process variables that indicate use of the aerosol provision device or aerosol provision system. One example is a flow sensor, pressure sensor, pressure switch or the like that is configured to detect airflow or a change in pressure caused by airflow when a user draws on the consumable 104.

The switch 114 may provide user interface functionality. In some examples, the circuitry 112 may include a user interface (UI) 116 that is separate from or that is or includes the switch. The UI may include one or more input devices and/or output devices to enable interaction between the user and the aerosol provision device 102. As described above with respect to the switch, examples of suitable input devices include pushbuttons, touch-sensitive surfaces and the like. The one or more output devices generally include devices configured to provide information in a human-perceptible form that may be visual, audible or tactile/haptic. Examples of suitable output devices include light sources such as light-emitting diodes (LEDs), quantum dot-based LEDs and the like. Other examples of suitable output devices include display devices (e.g., electronic visual displays), touchscreens (integrated touch-sensitive surface and display device), loudspeakers, vibration motors and the like.

In some examples, the circuitry 112 includes processing circuitry 118 configured to perform data processing, application execution, or other processing, control or management services according to one or more example implementations. The processing circuitry may include a processor embodied in a variety of forms such as at least one processor core, microprocessor, coprocessor, controller, microcontroller or various other computing or processing devices including one or more integrated circuits such as, for example, an ASIC (application specific integrated circuit), an FPGA (field programmable gate array), some combination thereof, or the like. In some examples, the processing circuitry may include memory coupled to or integrated with the processor, and which may store data, computer program instructions executable by the processor, some combination thereof, or the like.

In some examples, the circuitry 112 includes at least one communication interface 120 to enable a wired or wireless connection to a computer or other digital equipment, directly or via one or more communication networks. Examples of suitable communication interfaces include a network adapter or network interface controller (NIC), a wireless NIC (WNIC), a transceiver integrated circuit or the like. In these and other similar examples, the communication interface may include an electrical connector for a wired connection or an antenna for a wireless connection. The at least one communication interface may support any of a number of different communication technologies over a suitable wired or wireless connection, such as those used for the Internet, cellular (mobile), wired and wireless local area networks (LANs), personal area networks (PANs), near field communication (NFC) or the like. More particular examples of suitable wireless PAN (WPAN) connections include Bluetooth®, Bluetooth low energy (Bluetooth LE), Zigbee®, infrared (e.g., IrDA), radio-frequency identification (RFID), Wireless USB and the like. Yet other examples of suitable WPAN connections include Wi-Fi Direct, as well as certain other connections based on or specified by IEEE 802.11 standards and that support direct device-to-device communication.

As also shown, in some examples, the housing 108 and thereby the aerosol provision device 102 may also include a coupler 122 structured to engage the consumable 104, and thereby couple the aerosol provision device with the consumable. The coupler may be or include a connector, fastener or the like that is configured to connect with a corresponding coupler of the consumable, such as by a press fit (or interference fit) connection, threaded connection, magnetic connection or the like. The coupler may be or include a receptacle such as a reservoir, tank, container, cavity, receiving chamber or the like that is structured to receive and contain the consumable or at least a portion of the consumable.

The consumable 104 is an article including aerosol-generating material 124 (also referred to as an aerosol precursor composition), part or all of which is intended to be consumed during use by a user. The aerosol provision system 100 may include one or more consumables, and each consumable may include one or more aerosol-generating materials. In some examples in which the aerosol provision system is a hybrid product, the aerosol provision system may include a liquid or gel aerosol-generating material to generate an aerosol, which may then pass through a second, solid aerosol-generating material to pick up additional constituents before reaching the user. These aerosol-generating materials may be within a single consumable or respective consumables that may be separately removable.

The aerosol-generating material 124 is capable of generating aerosol, for example when heated, irradiated or energized in any other way. The aerosol-generating material may be, for example, in the form of a solid, semi-solid, liquid or gel. The aerosol-generating material may include an “amorphous solid,” which may be alternatively referred to as a “monolithic solid” (i.e., non-fibrous). In some examples, the amorphous solid may be a dried gel. The amorphous solid is a solid material that may retain some fluid, such as liquid, within it. In some examples, the aerosol-generating material may include from about 50 wt %, 60 wt % or 70 wt % of amorphous solid, to about 90 wt %, 95 wt % or 100 wt % of amorphous solid.

The aerosol-generating material 124 may include one or more of each of a number of constituents such as an active substance 126, flavorant 128, aerosol-former material 130 or other functional material 132.

The active substance 126 may be a physiologically active material, which is a material intended to achieve or enhance a physiological response such as improved alertness, improved focus, increased energy, increased stamina, increased calm or improved sleep. The active substance may for example be selected from nutraceuticals, nootropics, psychoactives. The active substance may be naturally occurring or synthetically obtained. The active substance may include, for example, nicotine, caffeine, GABA (7-aminobutyric acid), L-theanine, taurine, theine, vitamins such as B6 or B12 (cobalamin) or C, melatonin, cannabinoids, terpenes, or constituents, derivatives, or combinations thereof. The active substance may include one or more constituents, derivatives or extracts of tobacco, cannabis or another botanical.

In some examples in which the active substance 126 includes derivatives or extracts, the active substance may be or include one or more cannabinoids or terpenes.

As noted herein, the active substance 126 may include or be derived from one or more botanicals or constituents, derivatives or extracts thereof. As used herein, the term “botanical” includes any material derived from plants including, but not limited to, extracts, leaves, bark, fibers, stems, roots, seeds, flowers, fruits, pollen, husk, shells or the like. Alternatively, the material may include an active compound naturally existing in a botanical, obtained synthetically. The material may be in the form of liquid, gas, solid, powder, dust, crushed particles, granules, pellets, shreds, strips, sheets, or the like. Example botanicals are tobacco, eucalyptus, star anise, hemp, cocoa, cannabis, fennel, lemongrass, peppermint, spearmint, rooibos, chamomile, flax, ginger, Ginkgo biloba, hazel, hibiscus, laurel, licorice (liquorice), matcha, mate, orange skin, papaya, rose, sage, tea such as green tea or black tea, thyme, clove, cinnamon, coffee, aniseed (anise), basil, bay leaves, cardamom, coriander, cumin, nutmeg, oregano, paprika, rosemary, saffron, lavender, lemon peel, mint, juniper, elderflower, vanilla, wintergreen, beefsteak plant, curcuma, turmeric, sandalwood, cilantro, bergamot, orange blossom, myrtle, cassis, valerian, pimento, mace, damien, marjoram, olive, lemon balm, lemon basil, chive, carvi, verbena, tarragon, geranium, mulberry, ginseng, theanine, theacrine, maca, ashwagandha, damiana, guarana, chlorophyll, baobab or any combination thereof. The mint may be chosen from the following mint varieties: Mentha arventis, Mentha c.v., Mentha niliaca, Mentha piperita, Mentha piperita citrata c.v., Mentha piperita c.v, Mentha spicata crispa, Mentha cardifolia, Mentha longifolia, Mentha suaveolens variegata, Mentha pulegium, Mentha spicata c.v. and Mentha suaveolens.

In yet other examples, the active substance 126 may be or include one or more of 5-hydroxytryptophan (5-HTP)/oxitriptan/Griffonia simplicifolia, acetylcholine, arachidonic acid (AA, omega-6), ashwagandha (Withania somnifera), Bacopa monniera, beta alanine, beta-hydroxy-beta-methylbutyrate (HMB), Centella asiatica, chai-hu, cinnamon, citicoline, cotinine, creatine, curcumin, docosahexaenoic acid (DHA, omega-3), dopamine, Dorstenia arifolia, Dorstenia Odorata, essential oils, GABA, Galphimia glauca, glutamic acid, hops, kaempferia parviflora (Thai ginseng), kava, L-carnitine, L-arginine, lavender oil, L-choline, liquorice, L-lysine, L-theanine, L-tryptophan, lutein, magnesium, magnesium L-threonate, myo-inositol, nardostachys chinensis, nitrate, oil-based extract of Viola odorata, oxygen, phenylalanine, phosphatidylserine, quercetin, resveratrol, Rhizoma gastrodiae, Rhodiola, Rhodiola rosea, rose essential oil, S-adenosylmethionine (SAMe), Sceletium tortuosum, schisandra, selenium, serotonin, skullcap, spearmint extract, spikenard, theobromine, tumaric, Turnera aphrodisiaca, tyrosine, vitamin A, vitamin B3, or yerba mate.

In some example implementations, the aerosol-generating material 124 includes a flavorant 128. As used herein, the terms “flavorant” and “flavor” refer to materials which, where local regulations permit, may be used to create a desired taste, aroma or other somatosensorial sensation in a product for adult consumers. Flavorants may include naturally occurring flavor materials, botanicals, extracts of botanicals, synthetically obtained materials, or combinations thereof (e.g., tobacco, cannabis, licorice (liquorice), hydrangea, eugenol, Japanese white bark magnolia leaf, chamomile, fenugreek, clove, maple, matcha, menthol, Japanese mint, aniseed (anise), cinnamon, turmeric, Indian spices, Asian spices, herb, wintergreen, cherry, berry, redberry, cranberry, peach, apple, orange, mango, clementine, lemon, lime, tropical fruit, papaya, rhubarb, grape, durian, dragon fruit, cucumber, blueberry, mulberry, citrus fruits, Drambuie, bourbon, scotch, whiskey, gin, tequila, rum, spearmint, peppermint, lavender, aloe vera, cardamom, celery, cascarilla, nutmeg, sandalwood, bergamot, geranium, khat, naswar, betel, shisha, pine, honey essence, rose oil, vanilla, lemon oil, orange oil, orange blossom, cherry blossom, cassia, caraway, cognac, jasmine, ylang-ylang, sage, fennel, wasabi, piment, ginger, coriander, coffee, hemp, a mint oil from any species of the genus Mentha, eucalyptus, star anise, cocoa, lemongrass, rooibos, flax, Ginkgo biloba, hazel, hibiscus, laurel, mate, orange skin, rose, tea such as green tea or black tea, thyme, juniper, elderflower, basil, bay leaves, cumin, oregano, paprika, rosemary, saffron, lemon peel, mint, beefsteak plant, curcuma, cilantro, myrtle, cassis, valerian, pimento, mace, damien, marjoram, olive, lemon balm, lemon basil, chive, carvi, verbena, tarragon, limonene, thymol, camphene), flavor enhancers, bitterness receptor site blockers, sensorial receptor site activators or stimulators, sugars and/or sugar substitutes (e.g., sucralose, acesulfame potassium, aspartame, saccharine, cyclamates, lactose, sucrose, glucose, fructose, sorbitol, or mannitol), and other additives such as charcoal, chlorophyll, minerals, botanicals, or breath freshening agents. Flavorants may be imitation, synthetic or natural ingredients or blends thereof. Flavorants may be in any suitable form, for example, liquid such as an oil, solid such as a powder, or gas.

In some example implementations, the flavorant 128 may include a sensate, which is intended to achieve a somatosensorial sensation which are usually chemically induced and perceived by the stimulation of the fifth cranial nerve (trigeminal nerve), in addition to or in place of aroma or taste nerves, and these may include agents providing heating, cooling, tingling, numbing effect. A suitable heat effect agent may be, but is not limited to, vanillyl ethyl ether and a suitable cooling agent may be, but not limited to eucolyptol, WS-3.

The aerosol-former material 130 may include one or more constituents capable of forming an aerosol. In some example implementations, the aerosol-former material may include one or more of glycerine, glycerol, propylene glycol, diethylene glycol, triethylene glycol, tetraethylene glycol, 1,3-butylene glycol, erythritol, meso-Erythritol, ethyl vanillate, ethyl laurate, a diethyl suberate, triethyl citrate, triacetin, a diacetin mixture, benzyl benzoate, benzyl phenyl acetate, tributyrin, lauryl acetate, lauric acid, myristic acid, and propylene carbonate.

The one or more other functional materials 132 may include one or more of pH regulators, colouring agents, preservatives, binders, fillers, stabilizers, and/or antioxidants. Suitable binders include, for example, pectin, guar gum, fruit pectin, citrus pectin, tobacco pectin, hydroxyethyl guar gum, hydroxypropyl guar gum, hydroxyethyl locust bean gum, hydroxypropyl locust bean gum, alginate, starch, modified starch, derivatized starch, methyl cellulose, ethyl cellulose, ethylhydroxymethyl cellulose, carboxymethyl cellulose, tamarind gum, dextran, pullalon, konjac flour or xanthan gum.

In some example implementations, the aerosol-generating material 124 may be present on or in a support to form a substrate 134. The support may be or include, for example, paper, card, paperboard, cardboard, reconstituted material (e.g., a material formed from reconstituted plant material, such as reconstituted tobacco, reconstituted hemp, etc.), a plastics material, a ceramic material, a composite material, glass, a metal, or a metal alloy. In some examples, the support includes a susceptor, which may be embedded within the aerosol-generating material, or on one or either side of the aerosol-generating material.

Although not separately shown, in some example implementations, the consumable 104 may further include a receptacle structured to engage the aerosol-generating material 124, or substrate 134 with the aerosol-generating material. The receptacle may be or include a reservoir, tank, container, cavity, receiving chamber or the like that is structured to receive and contain the aerosol-generating material or the substrate. The consumable may include an aerosol-generating material transfer component (also referred to as a liquid transport element) configured to transport aerosol-generating material to the aerosol generator 106. The aerosol-generating material transfer component may be adapted to wick or otherwise transport aerosol-generating material via capillary action. In some examples, the aerosol-generating material transfer component may include a microfluidic chip, a micro pump or other suitable component to transport aerosol-generating material.

The aerosol generator 106 (also referred to as an atomizer, aerosolizer or aerosol production component) is configured to energize the aerosol-generating material 124 to generate an aerosol, or otherwise cause generation of an aerosol from the aerosol-generating material. More particularly, in some examples, the aerosol generator may be powered by the power source 110 under control of the circuitry 112 to energize the aerosol-generating material to generate an aerosol.

In some example implementations, the aerosol generator 106 is an electric heater configured to perform electric heating in which electrical energy from the power source is converted to heat energy, which the aerosol-generating material is subject to so as to release one or more volatiles from the aerosol-generating material to form an aerosol. Examples of suitable forms of electric heating include resistance (Joule) heating, induction heating, dielectric and microwave heating, radiant heating, arc heating and the like. More particular examples of suitable electric heaters include resistive heating elements such as wire coils, flat plates, prongs, micro heaters or the like.

In some example implementations, the aerosol generator 106 is configured to cause an aerosol to be generated from the aerosol-generating material without heating, or with only secondary heating. For example, the aerosol generator may be configured to subject the aerosol-generating material to one or more of increased pressure, vibration, or electrostatic energy. More particular examples of these aerosol generators include jet nebulizers, ultrasonic wave nebulizers, vibrating mesh technology (VMT) nebulizers, surface acoustic wave (SAW) nebulizers, and the like.

A jet nebulizer is configured to use compressed gas (e.g., air, oxygen) to break up aerosol-generating material 124 into an aerosol, and an ultrasonic wave nebulizer is configured to use ultrasonic waves to break up aerosol-generating material into an aerosol. A VMT nebulizer includes a mesh, and a piezo material (e.g., piezoelectric material, piezomagnetic material) that may be driven to vibrate and cause the mesh to break up aerosol-generating material into an aerosol. A SAW nebulizer is configured to use surface acoustic waves or Rayleigh waves to break up aerosol-generating material into an aerosol.

In some examples, the aerosol generator 106 may include a susceptor, or the susceptor may be part of the substrate 134. The susceptor is a material that is heatable by penetration with a varying magnetic field generated by a magnetic field generator that may be separate from or part of the aerosol generator. The susceptor may be an electrically-conductive material, so that penetration thereof with a varying magnetic field causes induction heating of the heating material. The heating material may be magnetic material, so that penetration thereof with a varying magnetic field causes magnetic hysteresis heating of the heating material. The susceptor in some examples may be both electrically-conductive and magnetic, so that the susceptor of these examples is heatable by both heating mechanisms.

Although not separately shown, either or both the aerosol provision device 102 or the consumable 104 may include an aerosol-modifying agent. The aerosol-modifying agent is a substance configured to modify the aerosol generated from the aerosol-generating material 124, such as by changing the taste, flavor, acidity or another characteristic of the aerosol. In various examples, the aerosol-modifying agent may be an additive or a sorbent. The aerosol-modifying agent may include, for example, one or more of a flavorant, colorant, water or carbon adsorbent. The aerosol-modifying agent may be a solid, semi-solid, liquid or gel. The aerosol-modifying agent may be in powder, thread or granule form. The aerosol-modifying agent may be free from filtration material. In some examples, the aerosol-modifying agent may be provided in an aerosol-modifying agent release component that is operable to selectively release the aerosol-modifying agent.

The aerosol provision system 100 and its components including the aerosol provision device 102, consumable 104, and aerosol generator 106 may be manufactured with any of a number of different form factors, and with additional or alternative components relative to those described above.

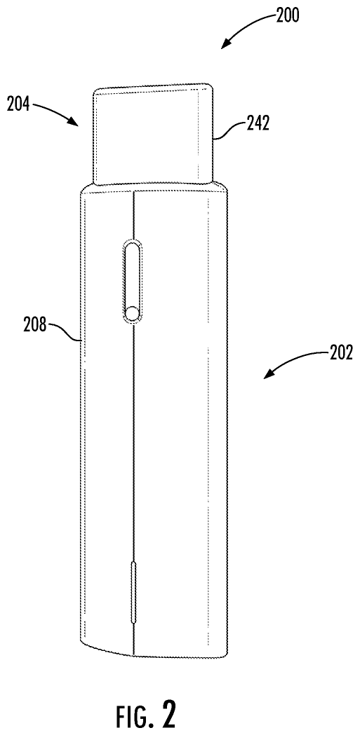

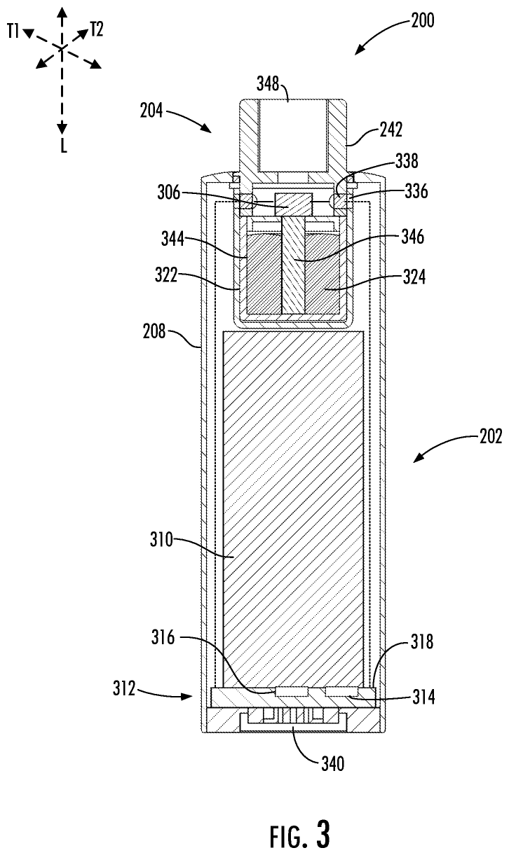

FIGS. 2 and 3 illustrate an aerosol provision system 200 in the form of a vapor product, and that in some example implementations may correspond to the aerosol provision system 100. As shown, the aerosol provision system 200 may include an aerosol provision device 202 (also referred to as a control body or power unit) and a consumable 204 (also referred to as a cartridge or tank), which may correspond to respectively the aerosol provision device 102 and the consumable 104. The aerosol provision system and in particular the consumable may also include an aerosol generator corresponding to the aerosol generator 106, and in the form of an electric heater 306 such as a heating element like a metal wire coil configured to convert electrical energy to heat energy through resistance (Joule) heating. The aerosol provision device and the consumable can be permanently or detachably aligned in a functioning relationship. FIGS. 2 and 3 illustrate respectively a perspective view and a partially cut-away side view of the aerosol provision system in a coupled configuration.

As seen in FIG. 2 and the cut-away view illustrated in FIG. 3, the aerosol provision device 202 and consumable 204 each include a number of respective components. The components illustrated in FIG. 3 are representative of the components that may be present in an aerosol provision device and consumable and are not intended to limit the scope of components that are encompassed by the present disclosure.

The aerosol provision device 202 may include a housing 208 (sometimes referred to as an aerosol provision device shell) that may include a power source 310. The housing may also include circuitry 312 with a switch in the form of a sensor 314, a user interface including a light source 316 that may be illuminated with use of the aerosol provision system 200, and processing circuitry 318 (also referred to as a control component). The housing may also include a receptacle in the form of a consumable receiving chamber 322 structured to engage the consumable 204. And the consumable may include an aerosol-generating material 324 that may correspond to aerosol-generating material 124, and that may include one or more of each of a number of constituents such as an active substance, flavorant, aerosol-former material or other functional material.

As also seen in FIG. 3, the aerosol provision device 202 may also include electrical connectors 336 positioned in the consumable receiving chamber 322 configured to electrically couple the circuitry and thereby the aerosol provision device with the consumable 204, and in particular electrical contacts 338 on the consumable. In this regard, the electrical connectors and electrical contacts may form a connection interface of the aerosol provision device and consumable. As also shown, the aerosol provision device may include an external electrical connector 340 to connect the aerosol provision device with one or more external devices. Examples of suitable external electrical connectors include USB connectors, proprietary connectors such as Apple's Lightning connector, and the like.

In various examples, the consumable 204 includes a tank portion and a mouthpiece portion. The tank portion and the mouthpiece portion may be integrated or permanently fixed together, or the tank portion may itself define the mouthpiece portion (or vice versa). In other examples, the tank portion and the mouthpiece portion may be separate and removably engaged with one another.

The consumable 204, tank portion and/or mouthpiece portion may be separately defined in relation to a longitudinal axis (L), a first transverse axis (T1) that is perpendicular to the longitudinal axis, and a second transverse axis (T2) that is perpendicular to the longitudinal axis and is perpendicular to the first transverse axis. The consumable can be formed of a housing 242 (sometimes referred to as the consumable shell) enclosing a reservoir 344 (in the tank portion) configured to retain the aerosol-generating material 324. In some examples, the consumable may include an aerosol generator, such as electric heater 306 in the illustrated example. In some examples, the electrical connectors 336 on the aerosol provision device 202 and electrical contacts 338 on the consumable may electrically connect the electric heater with the power source 310 and/or circuitry 312 of the aerosol provision device.

As shown, in some examples, the reservoir 344 may be in fluid communication with an aerosol-generating material transfer component 346 adapted to wick or otherwise transport aerosol-generating material 324 stored in the reservoir housing to the electric heater 306. At least a portion of the aerosol-generating material transfer component may be positioned proximate (e.g., directly adjacent, adjacent, in close proximity to, or in relatively close proximity to) the electric heater. The aerosol-generating material transfer component may extend between the electric heater and the aerosol-generating material stored in the reservoir, and at least a portion of the electric heater may be located above a proximal end the reservoir. For the purposes of the present disclosure, it should be understood that the term “above” in this particular context should be interpreted as meaning toward a proximal end of the reservoir and/or the consumable 204 in direction substantially along the longitudinal axis (L). Other arrangements of the aerosol-generating material transfer component are also contemplated within the scope of the disclosure. For example, in some example implementations, the aerosol-generating material transfer component may be positioned proximate a distal end of the reservoir and/or arranged transverse to the longitudinal axis (L).

The electric heater 306 and aerosol-generating material transfer component 346 may be configured as separate elements that are fluidly connected, the electric heater and aerosol-generating material transfer component or may be configured as a combined element. For example, in some implementations an electric heater may be integrated into an aerosol-generating material transfer component. Moreover, the electric heater and the aerosol-generating material transfer component may be formed of any construction as otherwise described herein. In some examples, a valve may be positioned between the reservoir 344 and electric heater, and configured to control an amount of aerosol-generating material 324 passed or delivered from the reservoir to the electric heater.

An opening 348 may be present in the housing 242 (e.g., at the mouth end of the mouthpiece portion) to allow for egress of formed aerosol from the consumable 204.

As indicated above, the circuitry 312 of the aerosol provision device 202 may include a number of electronic components, and in some examples may be formed of a circuit board such as a PCB that supports and electrically connects the electronic components. The sensor 314 (switch) may be one of these electronic components positioned on the circuit board. In some examples, the sensor may comprise its own circuit board or other base element to which it can be attached. In some examples, a flexible circuit board may be utilized. A flexible circuit board may be configured into a variety of shapes. In some examples, a flexible circuit board may be combined with, layered onto, or form part or all of a heater substrate.

In some examples, the reservoir 344 may be a container for storing the aerosol-generating material 324. In some examples, the reservoir may be or include a fibrous reservoir with a substrate with the aerosol-generating material present on or in a support. For example, the reservoir can comprise one or more layers of nonwoven fibers substantially formed into the shape of a tube encircling the interior of the housing 242, in this example. The aerosol-generating material may be retained in the reservoir. Liquid components, for example, may be sorptively retained by the reservoir. The reservoir may be in fluid connection with the aerosol-generating material transfer component 346. The aerosol-generating material transfer component may transport the aerosol-generating material stored in the reservoir via capillary action—or via a micro pump—to the electric heater 306. As such, the electric heater is in a heating arrangement with the aerosol-generating material transfer component.

In use, when a user draws on the aerosol provision system 200, airflow is detected by the sensor 314, and the electric heater 306 is activated to energize the aerosol-generating material 324 to generate an aerosol. Drawing upon the mouth end of the aerosol provision system causes ambient air to enter and pass through the aerosol provision system. In the consumable 204, the drawn air combines with the aerosol that is whisked, aspirated or otherwise drawn away from the electric heater and out the opening 348 in the mouth end of the aerosol provision system.

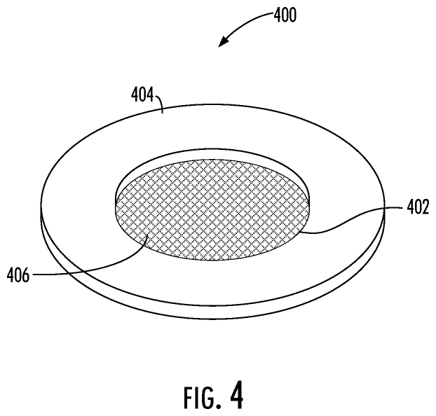

Again, as shown in FIGS. 2 and 3, the aerosol generator of the aerosol provision system 200 is an electric heater 306 designed to heat the aerosol-generating material 324 to generate an aerosol. In other implementations, the aerosol generator is designed to break up the aerosol-generating material without heating, or with only secondary heating. FIG. 4 illustrates a nebulizer 400 that may be used to implement the aerosol generator of an aerosol provision system, according to some these other example implementations.

As shown in FIG. 4, the nebulizer 400 includes a mesh plate 402 and a piezo material 404 that may be affixed to one another. The piezo material may be driven to vibrate and cause the mesh plate to break up aerosol-generating material into an aerosol. In some examples, the nebulizer may also include a supporting component located on a side of the mesh plate opposite the piezo material to increase the longevity of the mesh plate, and/or an auxiliary component between the mesh plate and the piezo material to facilitate interfacial contact between the mesh plate and the piezo material.

In various example implementations, the mesh plate 402 may have a variety of different configurations. The mesh plate may have a flat profile, a domed shape (concave or convex with respect to the aerosol-generating material), or a flat portion and a domed portion. The mesh plate defines perforations 406 that may be substantially uniform or vary in size across a perforated portion of the mesh plate. The perforations may be circular openings or non-circular openings (e.g., oval, rectangular, triangular, regular polygon, irregular polygon). In three-dimensions, the perforations may have a fixed cross section such as in the case of cylindrical perforations with a fixed circular cross section, or a variable cross section such as in the case of truncated cone perforations with a variable circular cross section. In other implementations, the perforations may be tetragonal or pyramidal.

The piezo material 404 may be or include a piezoelectric material or a piezomagnetic material. A piezoelectric material may be coupled to circuitry configured to produce an oscillating electric signal to drive the piezoelectric material to vibrate. For a piezomagnetic material, the circuitry may produce a pair of antiphase, oscillating electric signals to drive a pair of magnets to produce antiphase, oscillating magnetic fields that drives the piezomagnetic material to vibrate.

The piezo material 404 may be affixed to the mesh plate 402, and vibration of the piezo material may in turn cause the mesh plate to vibrate. The mesh plate may be in contact with or immersed in aerosol-generating material, in sufficient proximity of aerosol-generating material, or may otherwise receive aerosol-generating material via an aerosol-generating material transfer component. The vibration of the mesh plate, then, may cause the aerosol-generating material to pass through the perforations 406 that break up the aerosol-generating material into an aerosol. More particularly, in some examples, aerosol-generating material may be driven through the perforations 406 in the mesh plate 402 resulting in aerosol particles. In other examples in which the mesh plate is in contact with or immersed in aerosol-generating material, the vibrating mesh plate may create ultrasonic waves within aerosol-generating material that cause formation of an aerosol at the surface of the aerosol-generating material.

As described above, hybrid products use a combination of aerosol-generating materials, and some hybrid products are similar to vapor products except that the aerosol generated from one aerosol-generating material may pass through a second aerosol-generating material to pick up additional constituents. Another similar aerosol provision system in the form of a hybrid product may therefore be constructed similar to the vapor product in FIGS. 2 and 3 (with an electric heater 306 or a nebulizer 400). The hybrid product may include a second aerosol-generating material through which aerosol from the aerosol-generating material 324 is passed to pick up additional constituents before passing through the opening 348 in the mouth end of the aerosol provision system.

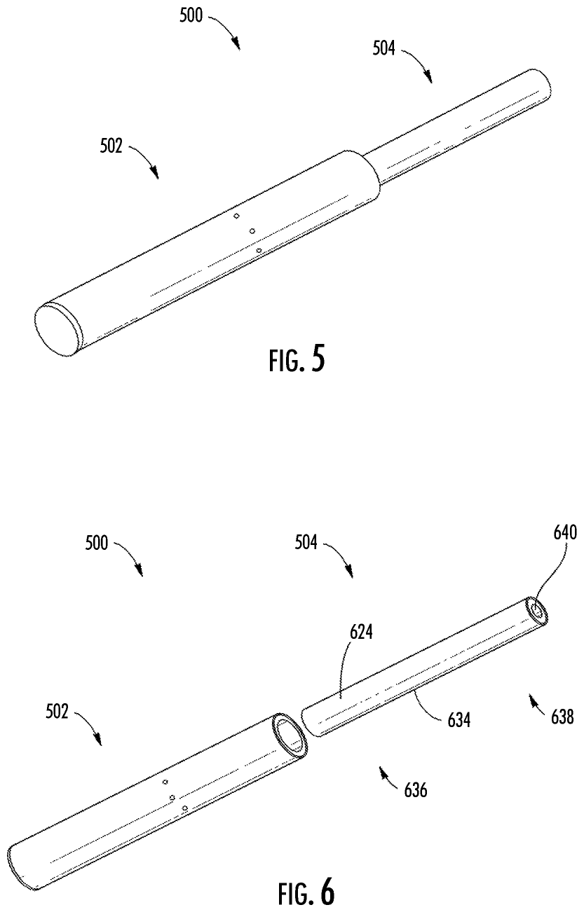

FIGS. 5, 6 and 7 illustrate an aerosol provision system 500 in the form of a heat-not-burn product, and that in some example implementations may correspond to the aerosol provision system 100. As shown, the aerosol provision system may include an aerosol provision device 502 (also referred to as a control body or power unit) and a consumable 504 (also referred to as an aerosol source member), which may correspond to respectively the aerosol provision device 102 and the consumable 104. The aerosol provision system and in particular the aerosol provision device may also include an aerosol generator corresponding to the aerosol generator 106, and in the form of an electric heater 706. The aerosol provision device and the consumable can be permanently or detachably aligned in a functioning relationship. FIG. 5 illustrates the aerosol provision system in a coupled configuration, whereas FIG. 6 illustrates the aerosol provision system in a decoupled configuration. FIG. 7 illustrates a partially cut-away side view of the aerosol provision system in the coupled configuration.

As seen in FIGS. 5, 6 and 7, the aerosol provision device 502 and consumable 504 each include a number of respective components. The components illustrated in the figures are representative of the components that may be present in an aerosol provision device and consumable and are not intended to limit the scope of components that are encompassed by the present disclosure.

The aerosol provision device 502 may include a housing 708 (sometimes referred to as an aerosol provision device shell) that may include a power source 710. The housing may also include circuitry 712 with a switch in the form of a sensor 714, a user interface including a light source 716 that may be illuminated with use of the aerosol provision system 500, and processing circuitry 718 (also referred to as a control component). In some examples, at least some of the electronic components of the circuitry may be formed of a circuit board or a flexible circuit board that supports and electrically connects the electronic components.

The housing 708 may also include a receptacle in the form of a consumable receiving chamber 722 structured to engage the consumable 504. The consumable may include an aerosol-generating material 624 that may correspond to aerosol-generating material 124, and that may include one or more of each of a number of constituents such as an active substance, flavorant, aerosol-former material or other functional material. And the aerosol-generating material may be present on or in a support to form a substrate 634.

In the coupled configuration of the aerosol provision system 500, the consumable 504 may be held in the consumable receiving chamber 722 in varying degrees. In some examples, less than half or approximately half of the consumable may be held in the receiving chamber. In other examples, more than half of the consumable may be held in the receiving chamber. In yet other examples, substantially the entire consumable may be held in the receiving chamber.

As shown in FIGS. 6 and 7, in various implementations of the present disclosure, the consumable 504 may include a heated end 636 sized and shaped for insertion into the aerosol provision device 502, and a mouth end 638 upon which a user draws to create the aerosol. In various implementations, at least a portion of the heated end may include the aerosol-generating material 624.

In some example implementations, the mouth end 638 of the consumable 504 may include a filter 640 made of a material such as cellulose acetate or polypropylene. The filter may additionally or alternatively contain strands of tobacco containing material. In some examples, at least a portion of the consumable may be wrapped in an exterior overwrap material, which may be formed of any material useful to provide additional structure, support and/or thermal resistance. In some examples, an excess length of the overwrap at the mouth end of the consumable may function to simply separate the aerosol-generating material 624 from the mouth of a user or to provide space for positioning of a filter material, or to affect draw on the consumable or to affect flow characteristics of the aerosol leaving the consumable during draw.

The electric heater 706 may perform electric heating of the aerosol-generating material 624 by resistance (Joule) heating, induction heating, dielectric and microwave heating, radiant heating, arc heating and the like. The electric heater may have a variety of different configurations. In some examples, at least a portion of the electric heater may surround or at least partially surround at least a portion of the consumable 504 including the aerosol-generating material when inserted in the aerosol provision device 502. In other examples, at least a portion of the electric heater may penetrate the consumable when the consumable is inserted into the aerosol provision device. In some examples, the substrate 634 material may include a susceptor, which may be embedded within the aerosol-generating material, or on one or either side of the aerosol-generating material.

Although shown as a part of the aerosol provision device 502, the electric heater 706 may instead be a part of the consumable 504. In some examples, the electric heater or a part of the electric heater may be may be combined, packaged or integral with (e.g., embedded within) the aerosol-generating material 624.

As shown, in some examples, the electric heater 706 may extend proximate an engagement end of the housing 708, and may be configured to substantially surround a portion of the heated end 636 of the consumable 504 that includes the aerosol-generating material 624. The electric heater 706 may be or may include an outer cylinder 742, and one or more resistive heating elements 744 such as prongs surrounded by the outer cylinder to create the consumable receiving chamber 722, which may extend from a receiving base 746 of the aerosol provision device to an opening 748 of the housing 708 of the aerosol provision device. In some examples, the outer cylinder may be a double-walled vacuum tube constructed of stainless steel so as to maintain heat generated by the resistive heating element(s) within the outer cylinder, and more particularly, maintain heat generated by the resistive heating element(s) within the aerosol-generating material.

Like the electric heater 706, the resistive heating element(s) 744 may have a variety of different configurations, and vary in number from one resistive heating element to a plurality of resistive heating elements. As shown, the resistive heating element(s) may extend from a receiving base 746 of the aerosol provision device 502. In some examples, the resistive heating element(s) may be located at or around an approximate radial center of the heated end 636 of the consumable 504 when inserted into the aerosol provision device. In some examples, the resistive heating element(s) may penetrate into the heated end of the consumable and in direct contact with the aerosol-generating material. In other examples, the resistive heating element(s) may be located inside (but out of direct contact with) a cavity defined by an inner surface of the heated end of the consumable.

In some examples, the resistive heating element(s) 744 of the electric heater 706 may be connected in an electrical circuit that includes the power source 710 such that electric current produced by the power source may pass through the resistive heating element(s). The passage of the electric current through the resistive heating element(s) may in turn cause the resistive heating element(s) to produce heat through resistance (Joule) heating.

In other examples, the electric heater 706 including the outer cylinder 742 and the resistive heating element(s) 744 may be configured to perform induction heating in which the outer cylinder may be connected in an electrical circuit that includes the power source 710, and the resistive heating element(s) may be connected in another electrical circuit. In this configuration, the outer cylinder and resistive heating element(s) may function as a transformer in which the outer cylinder is an induction transmitter, and the resistive heating element(s) is/are an induction receiver. In some of these examples, the outer cylinder and the resistive heating element(s) may parts of the aerosol provision device 502. In other of these examples, the outer cylinder may be a part of the aerosol provision device, and the resistive heating element(s) may be a part of the consumable 504.

The outer cylinder 742 may be provided an alternating current directly from the power source 710, or indirectly from the power source in which an inverter (as part of the circuitry 712) is configured to convert direct current from the power source to an alternating current. The alternating current drives the outer cylinder to generate an oscillating magnetic field, which induces eddy currents in the resistive heating element(s) 744. The eddy currents in turn cause the resistive heating element(s) to generate heat through resistance (Joule) heating. In these examples, the resistive heating element(s) may be wirelessly heated to form an aerosol from the aerosol-generating material 624 positioned in proximity to the resistive heating element(s).

In various example implementations, the aerosol provision device 502 may include an air intake 750 (e.g., one or more openings or apertures) in the housing 708 (and perhaps also the receiving base 746) to enable airflow into the consumable receiving chamber 722. When a use draws on the mouth end 638 of the consumable 504, the airflow may be drawn through the air intake into the receiving chamber, pass into the consumable, and drawn through the aerosol-generating material 624. The airflow may be detected by the sensor 714, and the electric heater 706 may be activated to energize the aerosol-generating material to generate an aerosol. The airflow may combine with the aerosol that is whisked, aspirated or otherwise drawn out an opening at the mouth end of the aerosol provision system. In examples including the filter 640, the airflow combined with the aerosol may be drawn out an opening of the filter at the mouth end.

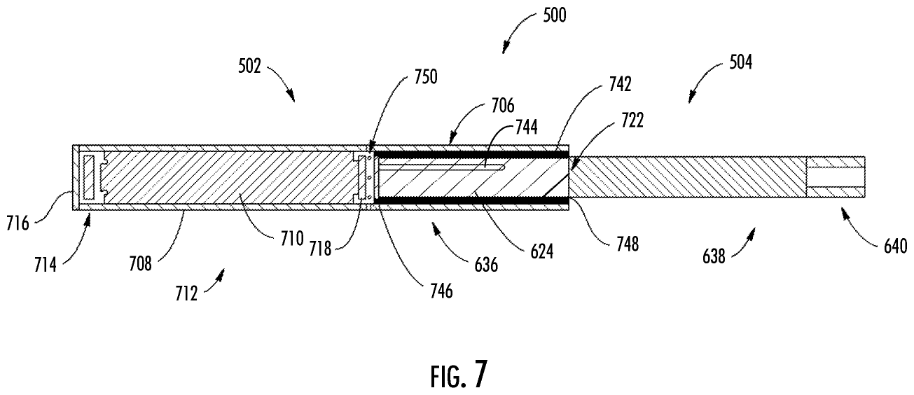

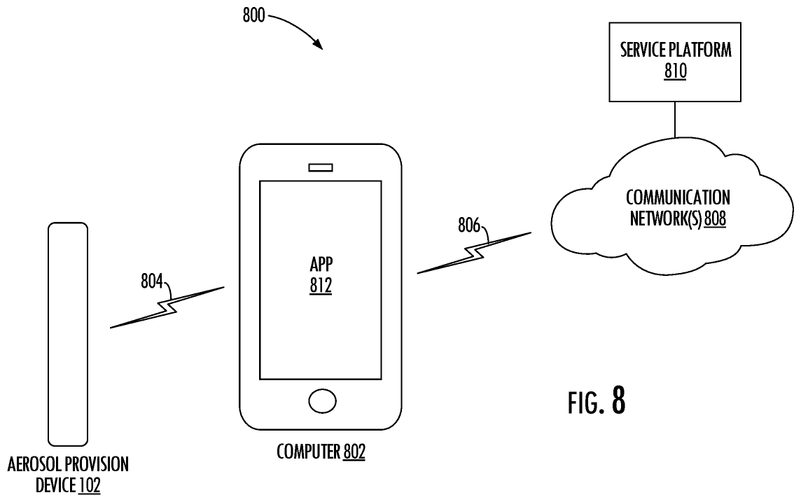

FIG. 8 illustrates a system 800 including an aerosol provision device 102 in wireless communication with a computer 802 external to the aerosol provision device (an external computer), according to various example implementations. This computer may be embodied as a number of different devices, such as any of a number of different mobile computers. More particular examples of suitable mobile computers include portable computers (e.g., laptops, notebooks, tablet computers), mobile phones (e.g., cell phones, smartphones), wearable computers (e.g., smartwatches) and the like. In other examples, the computer may be embodied as other than a mobile computer, such as in the manner of a desktop computer, server computer or the like.

In some examples, the at least one communication interface 120 of the aerosol provision device 102 is configured to enable a wireless connection 804 to the computer 802. As explained above, the wireless connection may be a WPAN connection such as Bluetooth®, Bluetooth LE, Zigbee®, infrared, RFID, Wireless USB, Wi-Fi Direct, as well as certain other connections based on or specified by IEEE 802.11 standards and that support direct device-to-device communication. The computer 802 may similarly include at least one communication interface to allow a wired or wireless connection 806 to a computer or other digital equipment, directly or via one or more communication networks 808.

The system 800 may further include a service platform 810, which may be embodied as a computer system accessible from the computer 802 via the one or more communication networks 808. The service platform may include one or more servers, such as may be provided by one or more blade servers, a cloud computing infrastructure or the like. In some examples, the service platform may be embodied as a distributed computing apparatus including multiple computers, such as may be used to provide a cloud computing infrastructure. And in these examples, the computers that form the service platform may be in communication with each other via at least one of the one or more communication networks.

The computer 802 may run, execute or otherwise provide application software (app) 812 or other interface through which the service platform 810 may be accessible. This application software or other interface may be or may be provided by a thin client and/or other client application, such as a progressive web application (PWA) or web browser application through which a webpage or website (e.g., web application) provided by the service platform may be accessible. As another example, the application or other interface may be or may be provided by a dedicated application, such as a mobile app installed on a computer embodied as a mobile computer. For purposes of illustration, and without limitation, example implementations of the present disclosure may more simply refer to the application software or other interface as an app.

The service platform 810 may be configured to provide one or more services to a user of the aerosol provision device 102 (and perhaps users of other aerosol provision devices), and may be accessed by the user through the app 812 on the computer 802. For example, the service platform may be operated by a manufacturer of an aerosol provision device, a vendor of an aerosol provision device or another entity with interest in the manufacture, distribution or maintenance of an aerosol provision device. The service platform may enable a user to access and use various features, such as features for management of an aerosol provision device, including those described below.

A user may access the service platform 810 through the app 812 on the computer 802, and the app may lead the user through activation of an aerosol provision device 102. This may include an age verification process in which the app may collect information that identifies the user, which may then be sent by the computer to the service platform 810 or a separate age verification system at which the information may be used to verify the user is of an age allowed to use the aerosol provision device. If not already registered, the user may register a user account with the service platform, and the user may be assigned or establish a username and password. The user may be led to pair or otherwise connect the computer and the aerosol provision device to setup a WPAN connection 804 between the computer and the aerosol provision device. The app may through the computer communicate with the aerosol provision device to acquire unique identifier (UID) of the aerosol provision device such as a serial number or MAC (media access control), which may then be linked to the user account. Similarly, a UID of the computer may be linked to the user account, which may thereby also link the aerosol provision device and the computer.

FIG. 9 is a schematic diagram that illustrates a user account 900 that may be provided by the service platform 810, and the user account's relationship with the computer 802 that includes the app 812, and with the aerosol provision device 102. As shown, the user account may store or otherwise include respective UIDs of the computer and the aerosol provision device. In some examples, the user account may also link one or more additional computers 802A, 802B (any of which may also include the app); and likewise, the user account may link one or more additional aerosol provision devices 102A, 102B, 102C. In these examples, the user account may also store or otherwise include respective UIDs of the one or more additional computers and/or aerosol provision devices. As also shown, the user account may interface with an age verification system 902 to verify the user is of an age allowed to use the aerosol provision device(s).

Returning to FIG. 8, the app 812 may enable the user to interact with the aerosol provision device 102 from the computer 802. In various examples, the app may enable the user to configure the aerosol provision device, receive data such as usage data from the aerosol provision device, send data such as one or more usage parameters to the aerosol provision device, or remotely control the aerosol provision device. In more particular examples, the app may enable the user to lock the aerosol provision device to disable use of the aerosol provision device with a consumable 104 and aerosol generator 106 to generate aerosol, or unlock the aerosol provision device to enable use of the aerosol provision device with a consumable and aerosol generator to generate aerosol.

The app 812 may further enable the user to setup an auto-lock in which the aerosol provision device 102 is configured to automatically lock when one or more conditions are satisfied. In some examples, the one or more conditions may include one or more of a time from a first draw on a consumable 104 engaged with aerosol provision device, a time from a last draw on the consumable, a number of cycles in which the aerosol generator 106 is powered to energize an aerosol-generating material 124, a time over which the aerosol generator is powered, or the like. Additionally or alternatively, in some examples, the one or more conditions may include a timeout condition in which the computer 802 (or another computer as may be designated by the user) is not in wireless range of the communication interface 120 of the aerosol provision device when an elapsed time reaches a specified period of time. Yet another example of a condition is a low-voltage condition which a voltage level of the power source 110 is below a specified cutoff voltage.

According to various example implementations, an auto-lock may be setup in which the processing circuitry 118 of the aerosol provision device 102 is configured to activate a timer to measure an elapsed time. The processing circuitry may be configured to then automatically lock the aerosol provision device, responsive to a timeout condition in which no computer on a whitelist of one or more computers is in wireless range of the communication interface 120 when the elapsed time reaches a specified period of time. The whitelist of one or more computers may be as designated by the user. As shown in FIG. 9, a whitelist 904 may include the computer 802 and any additional computers 802A, 802B linked in the user account 900 (any of which may be individually referred to as computer 800).

Again, the communication interface 120 of the aerosol provision device 102 is configured to enable a wireless connection 804 (e.g., a WPAN connection) to a computer 802 (one or more computers); and in some examples, the wireless range may be a WPAN range of the aerosol provision device. The wireless range may be indicated by sensitivity of the communication interface. In this regard, the sensitivity is or includes a measure of a lowest power level at which the communication interface can maintain the wireless connection, and interpret data carried by a wireless signal over the wireless connection.

A computer 802 on the whitelist 904 in wireless range of the communication interface 120 may be established in a number of different manners. In some examples, the computer in wireless range may be established by the wireless connection 804 with the computer; or in some further examples, by the wireless connection in an active state. In some examples, the computer in wireless range may be established further by verification that the computer and the aerosol provision device 102 are linked in a user account 900 provided by a service platform 810 that is accessible from the computer. As explained above, the computer and the aerosol provision device may be linked in the user account by respective UIDs. And in some further examples, the one or more computers on the whitelist and the aerosol provision device may be linked in the user account by respective UIDs.

In some examples, the specified period of time for the timeout condition may be marked by an absence of any computer 802 on the whitelist 904 in wireless range, when the elapsed time reaches the specified period of time, and perhaps also one or more times before the elapsed time reaches the specified period of time. In this regard, as the elapsed time is measured, the processing circuitry 118 of the aerosol provision device 102 may send a ping command from the aerosol provision device 102 via communication interface 120. This ping command may be sent to the one or more computers 802, 802A, 802B on the whitelist 904 to identify any computer on the whitelist that is in wireless range of the communication interface 120. The processing circuitry may be configured to receive a response to the ping command (at the aerosol provision device via communication interface) from a computer on the whitelist; and the processing circuitry may be configured to reset the timer and thereby the elapsed time, responsive to the response to the ping command.

The aerosol delivery device 102 may ping the one or more computers 802, 802A, 802B one or more times as the elapsed time is measured. In this regard, the ping command may be sent to the one or more computers when the elapsed time reaches the specified period of time. The ping command may also be sent to the one or more computers one or more times before the elapsed time reaches the specified period of time. And in some further more particular examples, the ping command may be sent to the one or more computers at regular intervals, including when the elapsed time reaches the specified period of time, and at one or more times before the elapsed time reaches the specified period of time.

In some examples, the response to the ping command from the computer 208 includes a UID of the computer, and the processing circuitry 118 of the aerosol provision device 102 may be further configured to match the UID to a corresponding UID of one of the one or more computers 802, 802A, 802B on the whitelist 904. The processing circuitry may be configured to then identify the computer 802 as one of the one or more computers, responsive a match of the UID.

In some examples, the ping command from the aerosol provision device 102 includes a UID of the aerosol provision device. And in some of these examples, the response to the ping command from the computer 802 may indicate the UID and thereby the aerosol provision device is linked to the computer. In this regard, the UID and thereby the aerosol provision device may be linked to the computer in the user account 900 provided by the service platform 810 that is accessible from the computer. The computer, then, may perform a verification that the computer and the aerosol provision device are linked in the user account, and send the response to the ping command, responsive to the verification.

In some examples, the aerosol provision device 102 may also be configured to ping the one or more computers 802, 802A, 802B on the whitelist 904 after the aerosol provision device is locked, which may be used as a means to unlock tie aerosol provision device. In this regard, after the aerosol provision device is locked, the processing circuitry 118 may be configured to send a ping command to the one or more computers on the whitelist to identify any computer on the whitelist that is in wireless range of the communication interface 120. The processing circuitry may be configured to unlock the aerosol provision device and perhaps also reset the timer (and thereby the elapsed time), responsive to a response to the ping command from a computer on the whitelist.

In various of these examples, the processing circuitry 118 may be triggered to ping the one or more computers to unlock the aerosol delivery device in a number of different manners. In some examples, the UI 116 of the aerosol provision device may be configured to receive a user input, and the ping command may be sent to the one or more computers responsive to the user input.

A user input received by the UI 116 may be used in some examples to lock the aerosol provision device 102. In particular, the processing circuitry 118 may be configured to lock the aerosol provision device responsive to the user input. Additionally or alternatively, the app 812 may be configured to receive user input. The processing circuitry may be configured to receive an indication of the user input from the app over the wireless connection 804 with the computer 802; and the processing circuitry may be configured to unlock the aerosol provision device, responsive to the indication of the user input from the app.

In addition to or in lieu of a timeout condition, the aerosol provision device 102 may be setup for one or more other conditions on which the aerosol provision device may be automatically locked. One example is a low-voltage condition in which the voltage level of the power source is below a specified cutoff voltage such as a cutoff voltage of the aerosol provision device, the processing circuitry or the aerosol generator 106. In these examples, the processing circuitry 118 may be configured to measure a voltage level of the power source 110, and automatically lock the aerosol provision device, responsive to a low-voltage condition.

To further illustrate example implementations of the present disclosure, FIG. 10 is a state diagram 1000 of an aerosol provision device 102 with an auto-lock setup for both a timeout condition and a low-voltage condition.

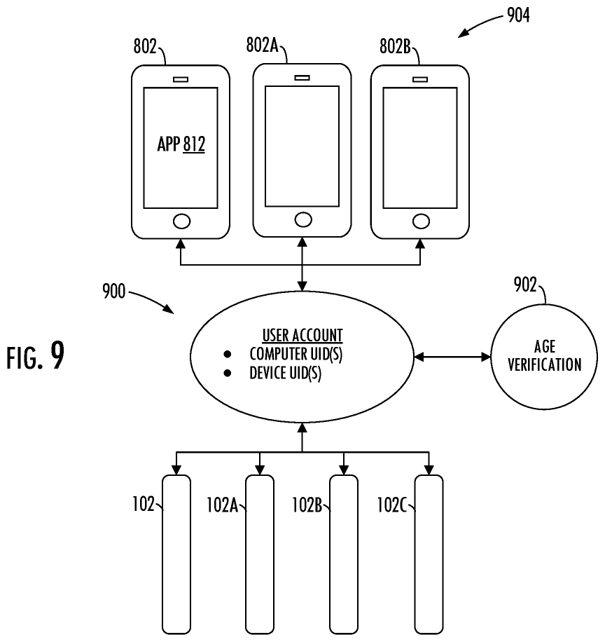

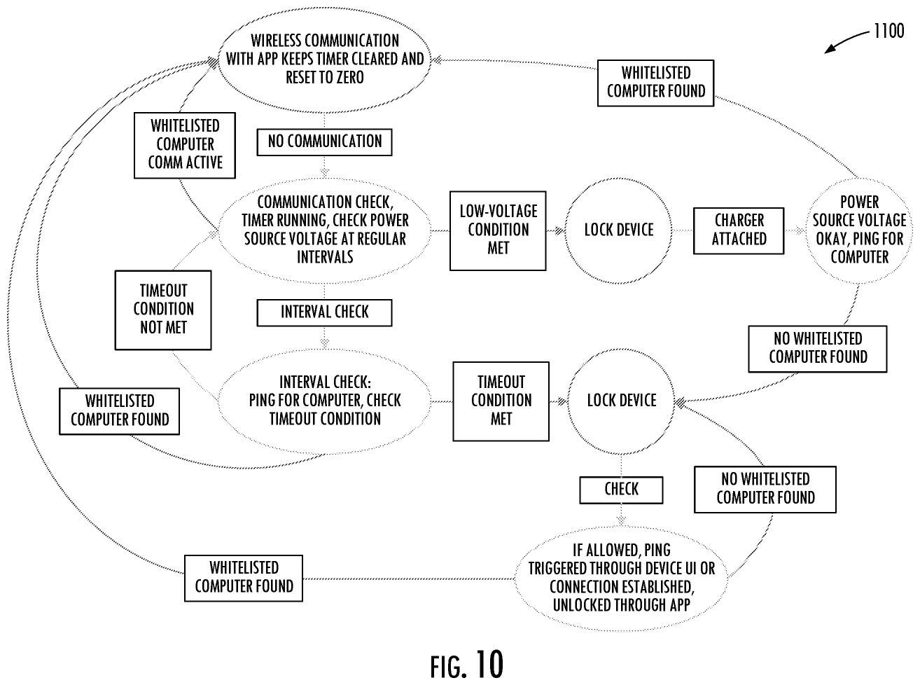

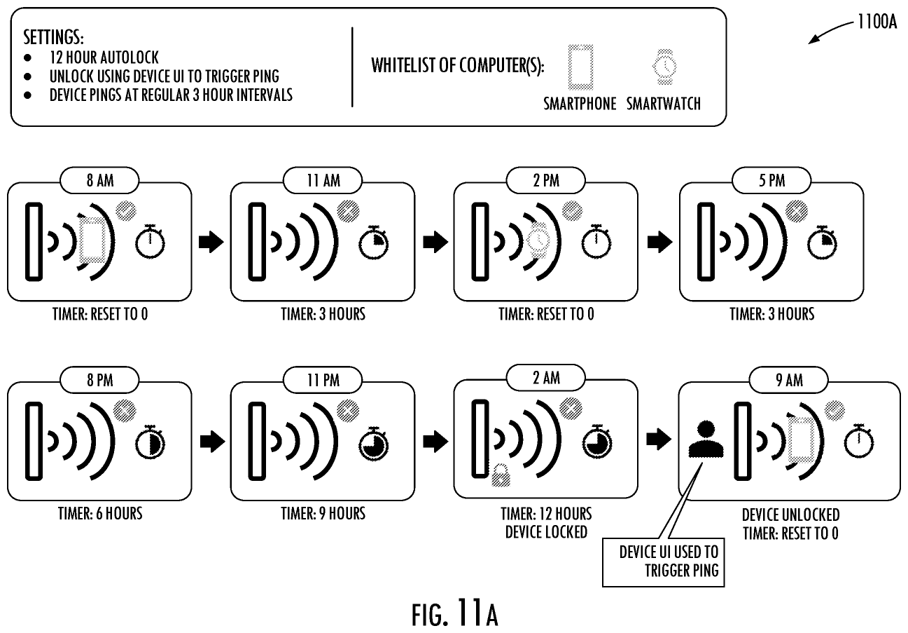

FIGS. 11A and 11B are customer journey maps 1100A and 1100B for use of the aerosol provision device 102 with auto-lock setup for a timeout condition, according to various example implementations. The customer journey map 1100A shown in FIG. 11A is for a passively-managed scenario in which the auto-lock may include a longer specified period of time (e.g., twelve hours). Also in this scenario, the aerosol provision device may be unlocked using the UI 116 to trigger the aerosol provision device to ping computer(s) 802 on the whitelist 904 (shown as including a smartphone and smartwatch) after the aerosol provision device is locked. As shown, the aerosol provision device may ping the computer(s) on the whitelist on regular three-hour intervals until the aerosol provision device is automatically locked at 2 AM. The UI is then used at 9 AM to trigger the aerosol provision device to ping the computer(s) to unlock the aerosol delivery device, when a response to the ping command indicates a computer on the whitelist is in wireless range of the communication interface 120.

The customer journey map 1100B shown in FIG. 11B is for a more actively-managed scenario in which the auto-lock may include a shorter specified period of time (e.g., three hours). Also in this scenario, the aerosol provision device may only be unlocked using the app 812 after the aerosol provision device is locked, and the UI 116 may be used to more directly lock the aerosol provision device. As shown, the aerosol provision device may ping the computer(s) 802 on the whitelist (shown as only including a smartphone) on regular three-hour intervals until the aerosol provision device is automatically locked at 2 PM. The app is then used at 6 PM to unlock the aerosol delivery device. The aerosol provision device is again locked at 7 PM through the UI, and again unlocked at 9 AM using the app. And yet again, the aerosol provision device is locked at 3 PM, following the timeout condition in which the computer on the whitelist is not in wireless range of the communication interface when the three-hour specified period of time passes.

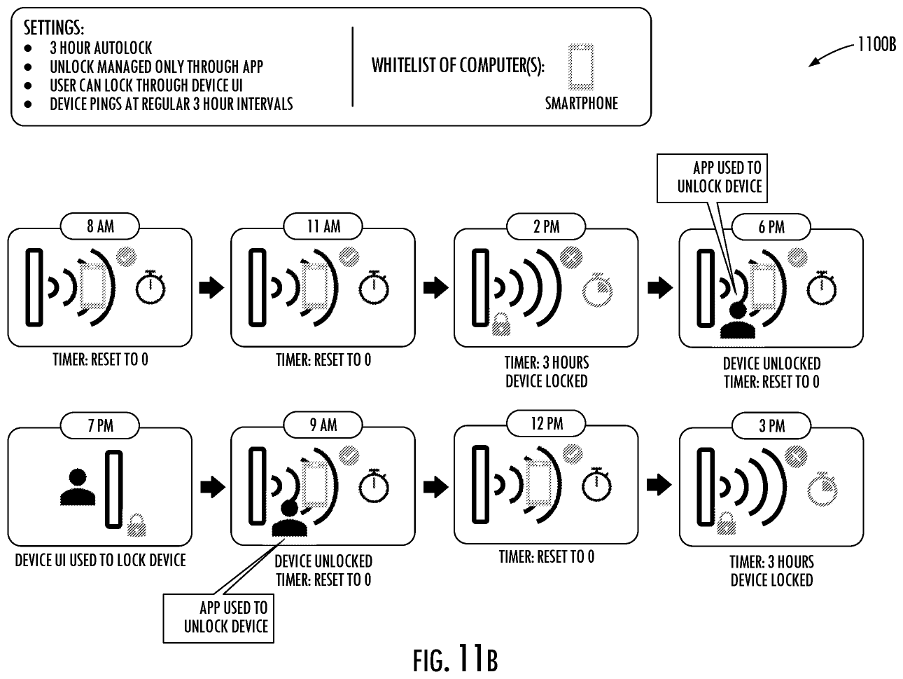

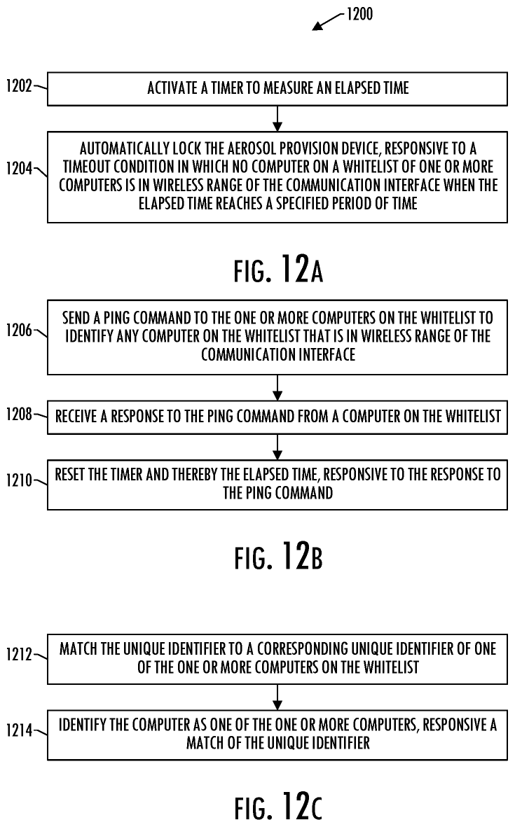

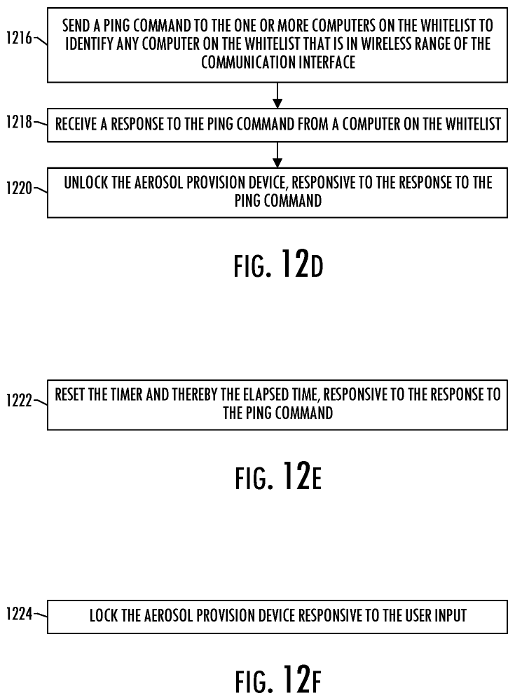

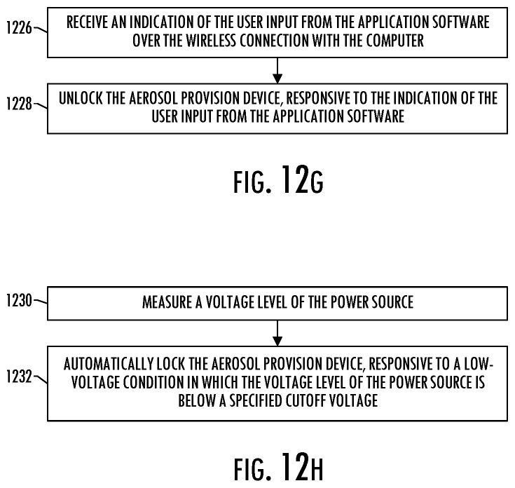

FIGS. 12A-12H are flowcharts illustrating various steps in a method 1200 of operating an aerosol provision device, according to various example implementations. As described above, the aerosol provision device includes a coupler structured to engage a consumable including aerosol-generating material, the aerosol provision device or the consumable further including an aerosol generator configured to energize the aerosol-generating material of the consumable to generate aerosol for delivery to a user. The method includes activating a timer to measure an elapsed time, as shown at block 1202 of FIG. 12A. The method also includes automatically locking the aerosol provision device, responsive to a timeout condition in which no computer on a whitelist of one or more computers is in wireless range of the communication interface when the elapsed time reaches a specified period of time, as shown at block 1204.

In some examples, the aerosol provision device is automatically locked at block 1204 to disable use of the aerosol provision device with the consumable and the aerosol generator to generate aerosol.

In some examples, the wireless connection is a wireless personal area network (WPAN) connection, and the wireless range is a WPAN range of the aerosol provision device.

In some examples, the wireless range is indicated by sensitivity of the communication interface.

In some examples, the sensitivity is or includes a measure of a lowest power level at which the communication interface can maintain the wireless connection, and interpret data carried by a wireless signal over the wireless connection.

In some examples, a computer on the whitelist in wireless range of the communication interface is established by the wireless connection with the computer.

In some examples, the computer in wireless range of the communication interface is established by the wireless connection in an active state.

In some examples, the computer in wireless range of the communication interface is established further by verification that the computer and the aerosol provision device are linked in a user account provided by a service platform that is accessible from the computer.

In some examples, the computer and the aerosol provision device are linked in the user account by respective unique identifiers.

In some examples, the one or more computers on the whitelist and the aerosol provision device are linked in the user account by respective unique identifiers.

In some examples, the specified period of time is marked by an absence of any computer on the whitelist in wireless range, when the elapsed time reaches the specified period of time.

In some examples, the specified period of time is further marked by the absence of any computer on the whitelist in wireless range, one or more times before the elapsed time reaches the specified period of time.

In some examples, as the elapsed time is measured, the method 1200 further includes sending at a ping command to the one or more computers on the whitelist to identify any computer on the whitelist that is in wireless range of the communication interface, as shown block 1206 of FIG. 12B. In some of these examples, the method also includes receiving a response to the ping command from a computer on the whitelist, as shown at block 1208. And the method includes resetting the timer and thereby the elapsed time, responsive to the response to the ping command, as shown at block 1210.

In some examples, the ping command is sent at block 1206 to the one or more computers when the elapsed time reaches the specified period of time.

In some examples, the ping command is also sent at block 1206 to the one or more computers one or more times before the elapsed time reaches the specified period of time.

In some examples, the ping command is sent at block 1206 to the one or more computers at regular intervals, including when the elapsed time reaches the specified period of time, and at one or more times before the elapsed time reaches the specified period of time.

In some examples, the response to the ping command includes a unique identifier of the computer. In some of these examples, the method 1200 further includes matching the unique identifier to a corresponding unique identifier of one of the one or more computers on the whitelist, as shown at block 1212 of FIG. 12C. And in some of these examples, the method includes identifying the computer as one of the one or more computers, responsive a match of the unique identifier, as shown at block 1214.

In some examples, the ping command includes a unique identifier of the aerosol provision device, and the response to the ping command indicates the unique identifier and thereby the aerosol provision device is linked to the computer.

In some examples, the unique identifier and thereby the aerosol provision device is linked to the computer in a user account provided by a service platform that is accessible from the computer, and the computer performs a verification that the computer and the aerosol provision device are linked in the user account, and sends the response to the ping command, responsive to the verification.

In some examples, after the aerosol provision device is locked at block 1204, the method 1200 further includes sending a ping command to the one or more computers on the whitelist to identify any computer on the whitelist that is in wireless range of the communication interface, as shown at block 1216 of FIG. 12D. In some of these examples, the method includes receiving a response to the ping command from a computer on the whitelist, as shown at block 1218. And the method includes unlocking the aerosol provision device, responsive to the response to the ping command, as shown at block 1220.

In some examples, the aerosol provision device is unlocked at block 1220 to enable use of the aerosol provision device with the consumable and the aerosol generator to generate aerosol.

In some examples, the method 1200 further includes resetting the timer and thereby the elapsed time, responsive to the response to the ping command, as shown at block 1222 of FIG. 12E.

In some examples, the aerosol provision device further includes a user interface receiving a user input, and the ping command is sent at block 1216 to the ping the one or more computers responsive to the user input.

In some examples, the aerosol provision device further includes a user interface receiving a user input. In some of these examples, the method 1200 further includes locking the aerosol provision device responsive to the user input, as shown at block 1224 of FIG. 12F.

In some examples, a computer on the whitelist includes application software receiving user input, and after the aerosol provision device is locked at block 1204, the method 1200 further includes receiving an indication of the user input from the application software over the wireless connection with the computer, as shown at block 1226 of FIG. 12G. In some of these examples, the method includes unlocking the aerosol provision device, responsive to the indication of the user input from the application software, as shown at block 1228.

In some examples, the aerosol provision device further includes a power source from which the aerosol provision device is powered, and the method 1200 further includes measuring a voltage level of the power source, as shown at block 1230 of FIG. 12H. And in some of these examples, the method includes automatically locking the aerosol provision device, responsive to a low-voltage condition in which the voltage level of the power source is below a specified cutoff voltage, as shown at block 1232.

In some examples, the specified cutoff voltage is a cutoff voltage of the aerosol provision device, the processing circuitry or the aerosol generator.

As explained above and reiterated below, the present disclosure includes, without limitation, the following example implementations.

Clause 1. An aerosol provision device comprising: a coupler structured to engage a consumable including aerosol-generating material, the aerosol provision device or the consumable further including an aerosol generator; a communication interface configured to enable a wireless connection; and processing circuitry configured to control power provided to the aerosol generator to energize the aerosol-generating material of the consumable to generate aerosol for delivery to a user, the processing circuitry further configured to at least: activate a timer to measure an elapsed time; and automatically lock the aerosol provision device, responsive to a timeout condition in which no computer on a whitelist of one or more computers is in wireless range of the communication interface when the elapsed time reaches a specified period of time.

Clause 2. The aerosol provision device of clause 1, wherein the processing circuitry is configured to automatically lock the aerosol provision device to disable use of the aerosol provision device with the consumable and the aerosol generator to generate aerosol.

Clause 3. The aerosol provision device of clause 1 or clause 2, wherein the wireless connection is a wireless personal area network (WPAN) connection, and the wireless range is a WPAN range of the aerosol provision device.

Clause 4. The aerosol provision device of any of clauses 1 to 3, wherein the wireless range is indicated by sensitivity of the communication interface.

Clause 5. The aerosol provision device of clause 4, wherein the sensitivity is or includes a measure of a lowest power level at which the communication interface can maintain the wireless connection, and interpret data carried by a wireless signal over the wireless connection.

Clause 6. The aerosol provision device of any of clauses 1 to 5, wherein a computer on the whitelist in wireless range of the communication interface is established by the wireless connection with the computer.

Clause 7. The aerosol provision device of clause 6, wherein the computer in wireless range of the communication interface is established by the wireless connection in an active state.

Clause 8. The aerosol provision device of clause 6 or clause 7, wherein the computer in wireless range of the communication interface is established further by verification that the computer and the aerosol provision device are linked in a user account provided by a service platform that is accessible from the computer.

Clause 9. The aerosol provision device of clause 8, wherein the computer and the aerosol provision device are linked in the user account by respective unique identifiers.

Clause 10. The aerosol provision device of clause 8 or clause 9, wherein the one or more computers on the whitelist and the aerosol provision device are linked in the user account by respective unique identifiers.

Clause 11. The aerosol provision device of any of clauses 1 to 10, wherein the specified period of time is marked by an absence of any computer on the whitelist in wireless range, when the elapsed time reaches the specified period of time.

Clause 12. The aerosol provision device of clause 11, wherein the specified period of time is further marked by the absence of any computer on the whitelist in wireless range, one or more times before the elapsed time reaches the specified period of time.

Clause 13. The aerosol provision device of any of clauses 1 to 12, wherein as the elapsed time is measured, the processing circuitry is further configured to: send a ping command to the one or more computers on the whitelist to identify any computer on the whitelist that is in wireless range of the communication interface; receive a response to ping the command from a computer on the whitelist; and reset the timer and thereby the elapsed time, responsive to the response to the ping command.

Clause 14. The aerosol provision device of clause 13, wherein the processing circuitry is configured to send the ping command to the one or more computers when the elapsed time reaches the specified period of time.

Clause 15. The aerosol provision device of clause 14, wherein the processing circuitry is configured to also send the ping command to the one or more computers one or more times before the elapsed time reaches the specified period of time.

Clause 16. The aerosol provision device of any of clauses 13 to 15, wherein the processing circuitry is configured to send the ping command to the one or more computers at regular intervals, including when the elapsed time reaches the specified period of time, and at one or more times before the elapsed time reaches the specified period of time.

Clause 17. The aerosol provision device of any of clauses 13 to 16, wherein the response to the ping command includes a unique identifier of the computer, and the processing circuitry is further configured to: match the unique identifier to a corresponding unique identifier of one of the one or more computers on the whitelist; and identify the computer as one of the one or more computers, responsive the match.

Clause 18. The aerosol provision device of any of clauses 13 to 17, wherein the ping command includes a unique identifier of the aerosol provision device, and the response to the ping command indicates the unique identifier and thereby the aerosol provision device is linked to the computer.

Clause 19. The aerosol provision device of clause 18, wherein the unique identifier and thereby the aerosol provision device is linked to the computer in a user account provided by a service platform that is accessible from the computer, and the computer is configured to perform a verification that the computer and the aerosol provision device are linked in the user account, and send the response to the ping command, responsive to the verification.

Clause 20. The aerosol provision device of any of clauses 1 to 19, wherein after the aerosol provision device is locked, the processing circuitry is further configured to: send a ping command to the one or more computers on the whitelist to identify any computer on the whitelist that is in wireless range of the communication interface; receive a response to the ping command from a computer on the whitelist; and unlock the aerosol provision device, responsive to the response to the ping command.

Clause 21. The aerosol provision device of clause 20, wherein the processing circuitry is configured to unlock the aerosol provision device to enable use of the aerosol provision device with the consumable and the aerosol generator to generate aerosol.

Clause 22. The aerosol provision device of clause 20 or clause 21, wherein the processing circuitry is further configured to reset the timer and thereby the elapsed time, responsive to the response to the ping command.

Clause 23. The aerosol provision device of any of clauses 20 to 22, wherein the aerosol provision device further comprises a user interface configured to receive a user input, and the processing circuitry is configured to send the ping command to the one or more computers responsive to the user input.

Clause 24. The aerosol provision device of any of clauses 1 to 23, wherein the aerosol provision device further comprises a user interface configured to receive a user input, and the processing circuitry is further configured to lock the aerosol provision device responsive to the user input.

Clause 25. The aerosol provision device of any of clauses 1 to 24, wherein a computer on the whitelist includes application software configured to receive user input, and after the aerosol provision device is locked, the processing circuitry is further configured to: receive an indication of the user input from the application software over the wireless connection with the computer; and unlock the aerosol provision device, responsive to the indication of the user input from the application software.

Clause 26. The aerosol provision device of any of clauses 1 to 25, wherein the aerosol provision device further comprises a power source from which the aerosol provision device is powered, and the processing circuitry is further configured to: measure a voltage level of the power source; and automatically lock the aerosol provision device, responsive to a low-voltage condition in which the voltage level of the power source is below a specified cutoff voltage.

Clause 27. The aerosol provision device of clause 26, wherein the specified cutoff voltage is a cutoff voltage of the aerosol provision device, the processing circuitry or the aerosol generator.

Clause 28. A method of operating an aerosol provision device that includes a coupler structured to engage a consumable including aerosol-generating material, the aerosol provision device or the consumable further including an aerosol generator configured to energize the aerosol-generating material of the consumable to generate aerosol for delivery to a user, the method comprising: activating a timer to measure an elapsed time; and automatically locking the aerosol provision device, responsive to a timeout condition in which no computer on a whitelist of one or more computers is in wireless range of the communication interface when the elapsed time reaches a specified period of time.

Clause 29. The method of clause 28, wherein the aerosol provision device is automatically locked to disable use of the aerosol provision device with the consumable and the aerosol generator to generate aerosol.

Clause 30. The method of clause 28 or clause 29, wherein the wireless connection is a wireless personal area network (WPAN) connection, and the wireless range is a WPAN range of the aerosol provision device.

Clause 31. The method of any of clauses 28 to 30, wherein the wireless range is indicated by sensitivity of the communication interface.

Clause 32. The method of clause 31, wherein the sensitivity is or includes a measure of a lowest power level at which the communication interface can maintain the wireless connection, and interpret data carried by a wireless signal over the wireless connection.

Clause 33. The method of any of clauses 28 to 32, wherein a computer on the whitelist in wireless range of the communication interface is established by the wireless connection with the computer.

Clause 34. The method of clause 33, wherein the computer in wireless range of the communication interface is established by the wireless connection in an active state.

Clause 35. The method of clause 33 or clause 34, wherein the computer in wireless range of the communication interface is established further by verification that the computer and the aerosol provision device are linked in a user account provided by a service platform that is accessible from the computer.

Clause 36. The method of clause 35, wherein the computer and the aerosol provision device are linked in the user account by respective unique identifiers.

Clause 37. The method of clause 35 or clause 36, wherein the one or more computers on the whitelist and the aerosol provision device are linked in the user account by respective unique identifiers.

Clause 38. The method of any of clauses 28 to 37, wherein the specified period of time is marked by an absence of any computer on the whitelist in wireless range, when the elapsed time reaches the specified period of time.

Clause 39. The method of clause 38, wherein the specified period of time is further marked by the absence of any computer on the whitelist in wireless range, one or more times before the elapsed time reaches the specified period of time.

Clause 40. The method of any of clauses 28 to 39, wherein as the elapsed time is measured, the method further comprises: sending a ping command to the one or more computers on the whitelist to identify any computer on the whitelist that is in wireless range of the communication interface; receiving a response to the ping command from a computer on the whitelist; and resetting the timer and thereby the elapsed time, responsive to the response to the ping command.

Clause 41. The method of clause 40, wherein the ping command is sent to the one or more computers when the elapsed time reaches the specified period of time.

Clause 42. The method of clause 41, wherein the ping command is also sent to the one or more computers one or more times before the elapsed time reaches the specified period of time.

Clause 43. The method of any of clauses 40 to 42, wherein the ping command is sent to the one or more computers at regular intervals, including when the elapsed time reaches the specified period of time, and at one or more times before the elapsed time reaches the specified period of time.

Clause 44. The method of any of clauses 40 to 43, wherein the response to the ping command includes a unique identifier of the computer, and the method further comprises: matching the unique identifier to a corresponding unique identifier of one of the one or more computers on the whitelist; and identifying the computer as one of the one or more computers, responsive a match of the unique identifier.

Clause 45. The method of any of clauses 40 to 44, wherein the ping command includes a unique identifier of the aerosol provision device, and the response to the ping command indicates the unique identifier and thereby the aerosol provision device is linked to the computer.

Clause 46. The method of clause 45, wherein the unique identifier and thereby the aerosol provision device is linked to the computer in a user account provided by a service platform that is accessible from the computer, and the computer performs a verification that the computer and the aerosol provision device are linked in the user account, and sends the response to the ping command, responsive to the verification.

Clause 47. The method of any of clauses 28 to 46, wherein after the aerosol provision device is locked, the method further comprises: sending a ping command to the one or more computers on the whitelist to identify any computer on the whitelist that is in wireless range of the communication interface; receiving a response to the ping command from a computer on the whitelist; and unlocking the aerosol provision device, responsive to the response to the ping command.

Clause 48. The method of clause 47, wherein the aerosol provision device is unlocked to enable use of the aerosol provision device with the consumable and the aerosol generator to generate aerosol.

Clause 49. The method of clause 47 or clause 48, wherein the method further comprises resetting the timer and thereby the elapsed time, responsive to the response to the ping command.

Clause 50. The method of any of clauses 47 to 49, wherein the aerosol provision device further includes a user interface receiving a user input, and the ping command is sent to the ping the one or more computers responsive to the user input.

Clause 51. The method of any of clauses 28 to 50, wherein the aerosol provision device further includes a user interface receiving a user input, and the method further comprises locking the aerosol provision device responsive to the user input.

Clause 52. The method of any of clauses 28 to 51, wherein a computer on the whitelist includes application software receiving user input, and after the aerosol provision device is locked, the method further comprises: receiving an indication of the user input from the application software over the wireless connection with the computer; and unlocking the aerosol provision device, responsive to the indication of the user input from the application software.

Clause 53. The method of any of clauses 28 to 52, wherein the aerosol provision device further includes a power source from which the aerosol provision device is powered, and the method further comprises: measuring a voltage level of the power source; and automatically locking the aerosol provision device, responsive to a low-voltage condition in which the voltage level of the power source is below a specified cutoff voltage.

Clause 54. The method of clause 53, wherein the specified cutoff voltage is a cutoff voltage of the aerosol provision device, the processing circuitry or the aerosol generator.

Many modifications and other implementations of the disclosure will come to mind to one skilled in the art to which this disclosure pertains having the benefit of the teachings presented in the foregoing descriptions and the associated figures. Therefore, it is to be understood that the disclosure is not to be limited to the specific implementations disclosed herein and that modifications and other implementations are intended to be included within the scope of the appended claims. Although specific terms are employed herein, they are used in a generic and descriptive sense only and not for purposes of limitation.

What is claimed is:

1. An aerosol provision device comprising:
a coupler structured to engage a consumable including aerosol-generating material, the aerosol provision device or the consumable further including an aerosol generator;
a communication interface configured to enable a wireless connection; and
processing circuitry configured to control power provided to the aerosol generator to energize the aerosol-generating material of the consumable to generate aerosol for delivery to a user, the processing circuitry further configured to at least:
activate a timer to measure an elapsed time; and
automatically lock the aerosol provision device, responsive to a timeout condition in which no computer on a whitelist of one or more computers is in wireless range of the communication interface when the elapsed time reaches a specified period of time.

2. The aerosol provision device of claim 1, wherein a computer on the whitelist in wireless range of the communication interface is established by the wireless connection with the computer.

3. The aerosol provision device of claim 2, wherein the computer in wireless range of the communication interface is established further by verification that the computer and the aerosol provision device are linked in a user account provided by a service platform that is accessible from the computer.

4. The aerosol provision device of claim 1, wherein as the elapsed time is measured, the processing circuitry is further configured to:
send a ping command to the one or more computers on the whitelist to identify any computer on the whitelist that is in wireless range of the communication interface;
receive a response to the ping command from a computer on the whitelist; and
reset the timer and thereby the elapsed time, responsive to the response to the ping command.

5. The aerosol provision device of claim 4, wherein the response to the ping command includes a unique identifier of the computer, and the processing circuitry is further configured to:
match the unique identifier to a corresponding unique identifier of one of the one or more computers on the whitelist; and
identify the computer as one of the one or more computers, responsive the match.

6. The aerosol provision device of claim 4, wherein the ping command includes a unique identifier of the aerosol provision device, and the response to the ping command indicates the unique identifier and thereby the aerosol provision device is linked to the computer.

7. The aerosol provision device of claim 1, wherein after the aerosol provision device is locked, the processing circuitry is further configured to:
send a ping command to the one or more computers on the whitelist to identify any computer on the whitelist that is in wireless range of the communication interface;
receive a response to the ping command from a computer on the whitelist; and
unlock the aerosol provision device, responsive to the response to the ping command.

8. The aerosol provision device of claim 7, wherein the processing circuitry is further configured to reset the timer and thereby the elapsed time, responsive to the response to the ping command.

9. The aerosol provision device of claim 7, wherein the aerosol provision device further comprises a user interface configured to receive a user input, and the processing circuitry is configured to send the ping command to the one or more computers responsive to the user input.

10. The aerosol provision device of claim 1, wherein the aerosol provision device further comprises a user interface configured to receive a user input, and the processing circuitry is further configured to lock the aerosol provision device responsive to the user input.

11. The aerosol provision device of claim 1, wherein a computer on the whitelist includes application software configured to receive user input, and after the aerosol provision device is locked, the processing circuitry is further configured to:
receive an indication of the user input from the application software over the wireless connection with the computer; and
unlock the aerosol provision device, responsive to the indication of the user input from the application software.

12. The aerosol provision device of claim 1, wherein the aerosol provision device further comprises a power source from which the aerosol provision device is powered, and the processing circuitry is further configured to:
measure a voltage level of the power source; and
automatically lock the aerosol provision device, responsive to a low-voltage condition in which the voltage level of the power source is below a specified cutoff voltage.

13. A method of operating an aerosol provision device that includes a coupler structured to engage a consumable including aerosol-generating material, the aerosol provision device or the consumable further including an aerosol generator configured to energize the aerosol-generating material of the consumable to generate aerosol for delivery to a user, the method comprising:
activating a timer to measure an elapsed time; and
automatically locking the aerosol provision device, responsive to a timeout condition in which no computer on a whitelist of one or more computers is in wireless range of the communication interface when the elapsed time reaches a specified period of time.

14. The method of claim 13, wherein a computer on the whitelist in wireless range of the communication interface is established by the wireless connection with the computer.

15. The method of claim 14, wherein the computer in wireless range of the communication interface is established further by verification that the computer and the aerosol provision device are linked in a user account provided by a service platform that is accessible from the computer.

16. The method of claim 13, wherein as the elapsed time is measured, the method further comprises:
sending a ping command to the one or more computers on the whitelist to identify any computer on the whitelist that is in wireless range of the communication interface;
receiving a response to the ping command from a computer on the whitelist; and
resetting the timer and thereby the elapsed time, responsive to the response to the ping command.

17. The method of claim 16, wherein the response to the ping command includes a unique identifier of the computer, and the method further comprises:
matching the unique identifier to a corresponding unique identifier of one of the one or more computers on the whitelist; and
identifying the computer as one of the one or more computers, responsive a match of the unique identifier.

18. The method of claim 16, wherein the ping command includes a unique identifier of the aerosol provision device, and the response to the ping command indicates the unique identifier and thereby the aerosol provision device is linked to the computer.

19. The method of claim 13, wherein after the aerosol provision device is locked, the method further comprises:
sending a ping command to the one or more computers on the whitelist to identify any computer on the whitelist that is in wireless range of the communication interface;
receiving a response to the ping command from a computer on the whitelist; and
unlocking the aerosol provision device, responsive to the response to the ping command.

20. The method of claim 19, wherein the method further comprises resetting the timer and thereby the elapsed time, responsive to the response to the ping command.

21. The method of claim 19, wherein the aerosol provision device further includes a user interface receiving a user input, and the ping command is sent to the one or more computers responsive to the user input.

22. The method of claim 13, wherein the aerosol provision device further includes a user interface receiving a user input, and the method further comprises locking the aerosol provision device responsive to the user input.

23. The method of claim 13, wherein a computer on the whitelist includes application software receiving user input, and after the aerosol provision device is locked, the method further comprises:
receiving an indication of the user input from the application software over the wireless connection with the computer; and
unlocking the aerosol provision device, responsive to the indication of the user input from the application software.

24. The method of claim 13, wherein the aerosol provision device further includes a power source from which the aerosol provision device is powered, and the method further comprises:
measuring a voltage level of the power source; and
automatically locking the aerosol provision device, responsive to a low-voltage condition in which the voltage level of the power source is below a specified cutoff voltage.
